(19) United States
(12) Patent Application Publication
(10) Pub. No.: US 2014/0331241 A1
(43) Pub. Date: Nov. 6, 2014

(54) SYSTEM AND METHOD WITH AUTOMATED MEDIA-FILE-BASED QUIZZING

(71) Applicant: KONINKLIJKE PHILIPS N.V., EINDHOVEN (NL)

(72) Inventors: Mauro Barbieri, Eindhoven (NL); Johannes Henricus Maria Korst, Eindhoven (NL); Serverius Petrus Paulus Pronk, Eindhoven (NL)

(21) Appl. No.: 14/350,886

(22) PCT Filed: Oct. 5, 2012
(86) PCT No.: PCT/IB2012/055368

§ 371 Date: Apr. 10, 2014

Related U.S. Application Data
(60) Provisional application No. 61/546,590, filed on Oct. 13, 2011.

(51) Int. Cl. H04N 21/475; H04N 21/2543

(52) U.S. Cl. CPC H04N 21/4758; H04N 21/2543
USPC 725/5; 725/24

(57) ABSTRACT

Automatic generation of questions and evaluation answers about a media item is provided for a system such as a video on demand system. A virtually unlimited number of questions can be generated without the need for subjective information. Questions about a media item are generated by selecting a media segment of the media item. At least part of the media item within the selected media segment is shown to a user. The user is asked to indicate a position within the media item where the user thinks that the segment is located. The indicated position is compared to the actual position of the segment to evaluate the answer.

### FIELD OF THE INVENTION

The invention relates to a computer system and method that makes use of media-file-based user quizzing by means of automatically generated questions.

### BACKGROUND

US patent application No 2009005141 discloses a media-file-based quizzing system that awards points to users if it determines that users have provided correct answers to questions. The system outputs questions to users and evaluates the answers. In the document, this is part of a computer quiz game.

For such quizzing systems it is generally desirable that the same questions are not posed too frequently, to prevent that users can know the answers beforehand. This could be avoided by providing a sufficiently large pool of predetermined questions. However, this becomes difficult when a quizzing system is used for a large and unpredictable number of users, such as on the Internet. As a result, the problem arises how the generation of questions can be automated in such a way that on one hand the questions are meaningful for human users and on the other hand the answers by the users can be automatically evaluated.

US 2009005141 mentions a solution to this problem that makes use of stored audio files. A system is mentioned that selects one of a plurality of the stored audio files, selects a portion of this audio file, plays it, receives a selection of a song title inputted by a user and compares the content of a song title field of the selected audio file with the received selection. Thus, the user is effectively presented with the question “what song is this portion from?” while the portion is played.

US 2009005141 mentions the possibility of selecting the audio file from files stored on a player owned by the user, more generally selecting media files including video and audio files, and selection from a plurality of players owned by different users that compete in a quiz game. In this way the questions are personalized for the players. Furthermore, the document mentions the use of extraction of additional information about these stored media files, in order to generate questions like “what is the name of the album in which this song appears?” etc.

A major part of the challenge of such automatically generated questions consists of identification of the song. Once the song is identified, the remainder of the question basically asks for the values of specific attributes of the song, so that the user's answer can be compared with a stored value of that attribute. This means that the number of possible automatically questions about a specific song is quite limited. Hence, if the questions would relate only to a single song, users could easily copy answers.

In various contexts, such as for promotion of video-on-demand orders of individual movies, it is desirable to provide for quizzing directed at individual media items. When this is done for a large and unpredictable number of users, it is desirable to provide for automatic generation of a wide variety of questions about an individual media item, in a way that allows for automated testing whether users have provided correct answers. Accordingly, the problem is posed to provide media-file-based user quizzing by means of automatically generated questions that allows for generation of a large number of different questions about the same media item.

### SUMMARY

It is an object to realize a computer system and method that makes use of media-file-based user quizzing wherein a large number of different questions about the same media item can be generated.

A method according to claim 1 is provided. A user question is generated by rendering a selected segment of a media item, such as a video item, and an answer is received in the form of an indication of a position where the user indicates that that segment is thought to be located within the media item. The segment may be selected for example by selecting a position of the segment in the media item, for example a temporal position in the stream of signal samples defined by the media item. For inputting the answer, a spatial selection range may be displayed for example, followed by inputting a user selection of a spatial position within the displayed spatial selection range, and deriving the user indicated position from the inputted spatial position. The correctness of the answer is checked for example by evaluating a difference between a position from which the segment was taken from the media item and the position indicated by the user. In this way, a virtually inexhaustible number of questions about a given media item can be generated automatically, and answers can be automatically checked without the need for further information. Questions about a media item may be used to promote orders for the media item, for example in a video-on-demand system. The user can be stimulated to view such promoting questions by rewarding correct answers with bonuses, such as a price reduction for ordering media items.

In an embodiment a predetermined payment amount may be awarded dependent on the difference between the first and second position.

In an embodiment, the method comprises directly or indirectly comparing at least part of a content of the media item in the selected segment with content of the media item outside the segment and adapting the question and/or the evaluation of the indicated second position dependent on a result of the comparison. Thus for example another segment may be selected if the comparison shows a match between the at least part of a content of the media item in the selected segment with content of the media item outside the segment. As another example, evaluation of the answer may comprise evaluating difference between the second position and each of the positions where matching segments have been found. if any, in addition to evaluating the difference with the first position. In this case the answer may be detected to be correct if the second position is within a predetermined distance of any one or more of the positions.

In an embodiment, the question is presented as a multiple choice question, wherein alternative answers correspond to different positions in a media item. Such a question can be generated automatically by selecting a plurality of positions. In a further embodiment, the selection of the plurality of positions may comprise comparing the segments, e.g. comparing images or fingerprints of images at the positions in the plurality, to exclude selections wherein more than one position in the plurality corresponds to a segment from the media item that have identical content or comprise the same image or images with the same fingerprint. This prevents ambiguous questions also when the media item contains repetitions of similar content.

In an alternative embodiment, the comparison of images or fingerprints of images may be used to mark more than one of the plurality positions in the multiple choice question as a correct answer. Similarly, when the question asks the user to indicate the answer by a selection from a continuous range, a plurality of positions of segments with content that matches the selected segment may be recorded as correct answers in response to the comparison.

In an embodiment a list of previously selected media segments of the media item may be maintained, and used to control selection, e.g. to disable a selection the same segment for different questions, or the selection of overlapping or closely spaced segments for different questions. This prevents repetition of questions.

In an embodiment the segment may be selected by randomly selecting a first position within a range of signal positions in the media item, using a random generator such as for example a true random generator or a pseudo random generator. In an embodiment, segments of limited duration of for example one second to one minute may be used.

In an embodiment only an audio component of a video stream in said media segment and/or a subtitle text is rendered, without displaying more than one image from the video stream. In this way questions can be made more difficult and storage space for storing the questions can be reduced.

A computer program product, such as a magnetic or optical disk or a semiconductor memory may be provided comprising a program of instructions for a programmable computer, to make the computer perform the method.

A system according to claim 13 is provided, which has a user quizzing component for automatically generating questions about a media item and evaluating user answers to the generated questions.

### BRIEF DESCRIPTION OF THE DRAWING

These and other objects and advantageous aspects will become apparent from a description of exemplary embodiments with reference to the following figures.

FIG. 1 shows a video on demand system

FIG. 2 shows a flow chart of question generation

FIG. 3, 3a shows examples of question images

### DETAILED DESCRIPTION OF EXEMPLARY EMBODIMENTS

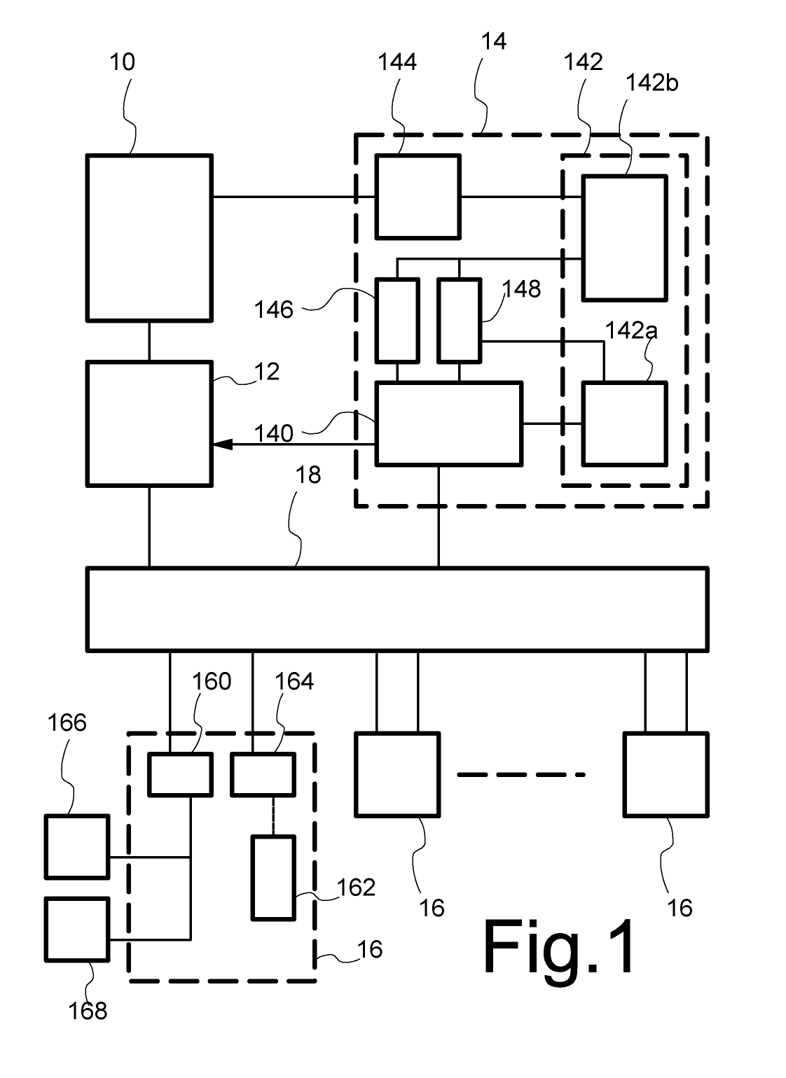

FIG. 1 shows a video on demand system, comprising a video storage system 10, a video delivery system 12, a video delivery control system 14, a plurality of user stations 16 and a communication network 18. Video delivery system 12 couples video storage system 10 to user stations 16 via communication network 18. Video delivery control system 14 is coupled to video delivery system 12 and to user stations 16, both via communication network 18.

By way of example, video delivery control system 14 is shown to be coupled directly to video delivery system 12. Also by way of example video delivery system 12 and video delivery control system 14 are shown coupled to user stations 16 via communication network 18.

Video delivery control system 14 comprises a video on demand service communication interface 140, a storage system 142 with first and second storage areas 142a,b for storing user account data and question-answer pairs respectively, a question-answer generator 144, a question selector 146, and a checking module 148. Video delivery control system 14 may be implemented using a programmable computer for example, with program modules containing instructions to make the computer to perform the communication interface function of communication interface 140, the question answer generation function of question-answer generator 144, the question selection function of question selector 146, and/or the checking function of checking module 148, respectively. First and second storage areas 142a,b may be different areas of a storage device of the programmable computer. Different parts of the user account data in first storage area 142a may be associated with different ones of the user stations, or with different user ID-codes. The user account data in may include debit data representing an amount of cost units to be charged to the user station 16 or a user, or credit data representing an amount cost units available to the user station 16 or a user. The debit data may be used by a billing system (not shown) to control sending of bills to the user. A crediting module (not shown) may be provided to add to the credit data.

User stations 16 (only one elaborated) may each contain a streaming unit 160, an input device 162 and a control unit 164. Streaming unit 160 is coupled to video delivery system 12 via communication network 18 and to a display screen 166 and an audio output 168. Control unit 164 is coupled to video delivery control system 14, input device 162, and streaming unit 160. Input device 162 may be a remote control unit for example, or a keyboard and/or a mouse. Although control unit 164 and streaming unit 160 may be combined in a single device, it should be appreciated that they may be separate devices, control unit 164 having its own display screen and/or audio output (not shown). In this case control unit 164 may be a personal computer for example.

In operation, a user may use the input device 162 of a user station 16 to select a video item and to transmit this selection to video delivery control system 14, which then controls video delivery system 12 to read video data representing the video item and to stream this data to streaming unit 160, which causes display screen 166 and an audio output 168 to render the video data as a series of displayed images and a sound signal. In addition video delivery control system 14 may update the debit data that is associated with user station 16 in storage system 142 to charge for the selected video item, or debit data for a user may be updated after the user has identified her- or himself When credit data is used, the case video delivery control system 14 may be configured to check the represented credit amount in the user account data for user station 16 (or for a user who has identified her- or himself) in storage system 142 and to control video delivery system 12 to stream the data only if the represented credit amount exceeds a charge value associated with the video item. In this case video delivery control system 14 may decrease the represented credit amount when the video item is transmitted.

Furthermore, user station 16 and video delivery control system 14 provide for operation in a quiz mode. In the quiz mode, the user is offered to play a quiz game. In the quiz mode, video delivery control system 14 controls video delivery system 12 to stream a segment of the video data representing a video item and user station 16 returns a response received via input device 162.

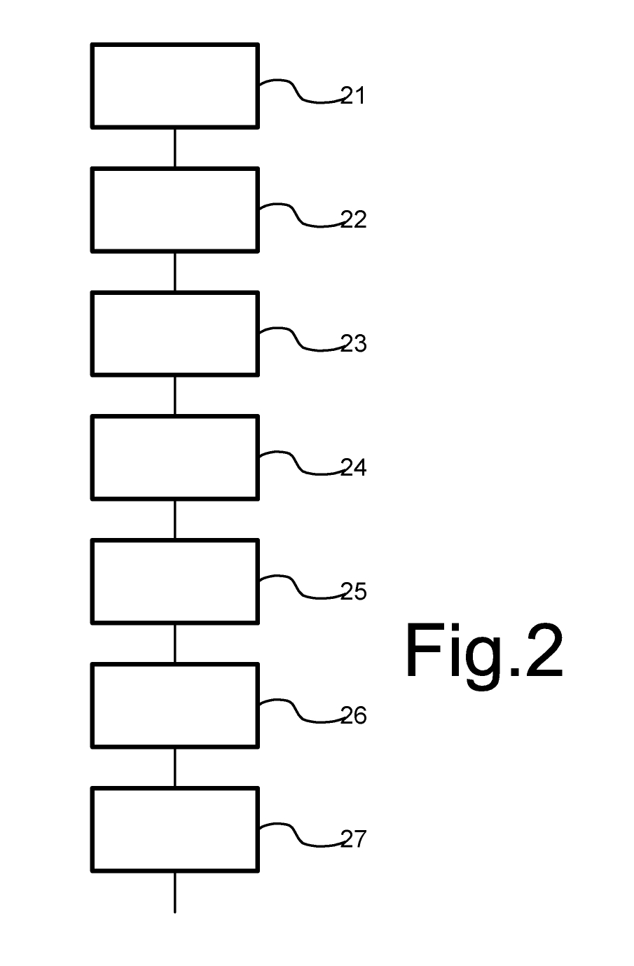

FIG. 2 shows a flow chart of quizzing. In a first step 21, question selector 146 inputs a selection of a video title for which a question is desired. In a second step 22, question selector 146 selects a section of the video stream that corresponds to the selected video title. The selection may be made for example by selecting a time value in a range from zero to the play duration of the video stream, the segment extending over a time interval of predetermined length from a time point with the selected time value. The time value may be selected randomly from a predetermined set of time values of starting points of scene cuts in the video stream for example, or randomly from all time values. Still in second step 22, question selector 146 copies the selected segment from video storage system 10 to second storage area 142b of storage system 142, in combination with an indication of the selected video title and an indication of a position of the segment in that title, as a representation of a question-answer pair. As used herein, random means true random or pseudo random (true random selection may be based e.g. on noise from a noise generator, pseudo random selection may be based e.g. according to mathematical sequence and/or dependent on timing of user responses).

In a third step 23, question selector 146 selects the question-answer pair. Question selector 146 sends the selected segment of the question-answer pair from second storage area 142b to communication interface 140. Question selector 146 sends the indication of the position of the segment of the question-answer pair to checking module 148. In a fourth step 24 communication interface 140 transmits a video stream with data from the selected segment to a user station 16. In a fifth step 25 user station 16 causes the segment to be played on display screen 166 and audio output 168. Furthermore, user station 16 causes a position selection input, such as a scroll bar or multiple choice buttons to be shown on display screen 166.

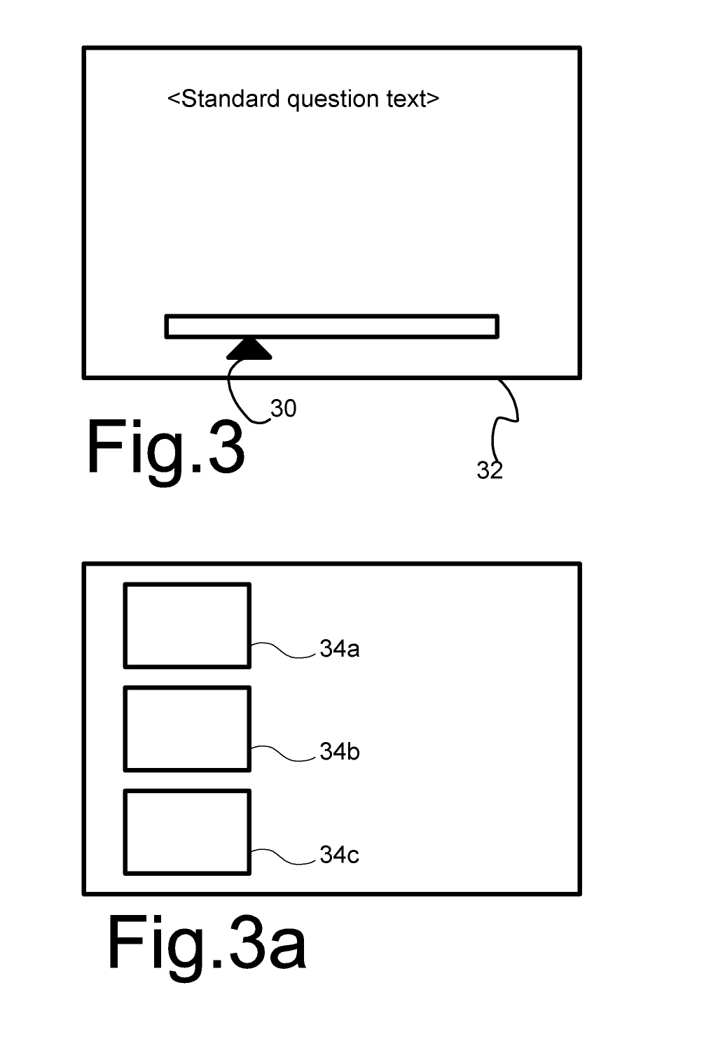

FIG. 3 shows an example of a resulting displayed image 32 on display screen 166, containing a scroll bar type position selection input 30 that may be shown superimposed on the displayed image or images from the video item. Control unit 164 may control the displayed position dependent on user input from input device 162. In addition a standard question text, such as “where is this clip located in this video item?” may be displayed. It should be noted that a standard question text can be used, independent of the video item, or only containing readily available text such as the title of the video item, whatever wording is selected.

In a sixth step 26 user station 16 receives a user response from input device 162, which represents a position selection in the position selection input 30 and user station 16 transmits data representing this response back to communication interface 140.

In a seventh step 27, communication interface 140 submits the response to checking module 148, which compares the response with the indication of the position of the segment. Checking module 148 updates user account data in first storage area 142a associated with the user station 16 (or the user that has identified her- or himself), dependent on the result of the comparison. Third to seventh step 23-27 may be part of a session wherein a user has identified her- or himself. In this case a user ID may used to select the user account data that will be updated.

If a credit amount is used, checking module 148 may increase the credit amount when the received response indicates a position in the video stream of the complete video title that differs by less than a threshold amount from the position indicated by the indication of the video segment from the question-answer pair. In another embodiment, checking module 148 may increase the credit amount as a function of the distance between the position indicated by the received response and the position indicated by the indication of the video segment from the question-answer pair. A function may be used that decreases continuously with increasing distance, for example. When a debit amount is used, the debit amount may be decreased similarly dependent on the result of the comparison.

Although an embodiment has been described wherein checking module 148 updates user account data only dependent on the comparison between the user response and the indication of the position of the segment, it should be appreciated that the update may be made to depend on other factors, such as the number of questions that have been answered previously from the same user station 16 (the size of the update being decreased with an increasing number of answers), or the time taken by the user to supply the answer after the start of play.

Although the flow chart describes an embodiment wherein one question answer pair is generated, it should be appreciated that second step 22 may be executed repeatedly to store a plurality of question-answer pairs in second storage area 142b of storage system 142 off line from posing the questions. Thus a plurality of different questions for the same video item may be generated, or for a plurality of different video items. In this case, third step 23 involves selecting one of the pre-stored question answer pairs and first step 21 and third and following steps 23 may be executed after generation and storage of a plurality of questions.

An embodiment has been described wherein posing the question involves rendering a segment of video and checking whether a user has inputted a position that is at least approximately equal to the position of the rendered segment in the video item. However, it should be appreciated that a question can be posed in different ways. For example a selection from a multiple choice input may be provided for. In this embodiment, question selector 146 may select a plurality of positions in the media item (e.g. at least three positions) for one question in second step 22, the segment being located in the media item at one of these positions.

Optionally, question selector 146 may use image fingerprints of images at the selected positions to exclude that segments at two or more of the selected positions in the video item are identical (computation and comparison of fingerprints of is known per se). Then in fifth step 25 user station 16 may cause an indication of each of the selected positions to be rendered on display screen 166 or audio output 168. In sixth step 26 user station 16 may receive a user selection from input device 162, which selects one of the indications. In seventh step 27, communication interface 140 submits the response to checking module 148, which compares the selection with the selection that corresponds with the rendered segment.

This embodiment can be combined with a version of fourth step 24 wherein communication interface 140 transmits only a text part and/or an audio part of a video stream for the selected segment to user station 16, plus optionally images from the video stream at the plurality of positions. In this embodiment fifth step 25 may comprise that user station 16 causes the images to be shown (for example as shown in FIG. 3a, with images 34a-c taken from different positions in the video item) and the text part and/or an audio part of the segment to be rendered. In sixth step 26 user station 16 may then receive a user selection from input device 162, indicating one of the displayed images. Thus, the user is effectively asked to indicate with which image the rendered text part and/or an audio part is associated.

In another embodiment, question selector 146 may use a comparison of images or image fingerprints of images at the selected position with images or image fingerprints of images elsewhere in the video item to allow for a plurality of correct answers. In this embodiments, a step may be added after third step 23 wherein question selector 146 uses a comparison of images or image fingerprints of images at the selected position with images or image fingerprints of images elsewhere in the video item. This will result in zero or more positions of matching segments. In this embodiment question selector 146 sends the indication of the positions of the matching segments to checking module 148 in addition to the positions of the segment of the question-answer pair. In a seventh step 27, checking module 148 compares the user response with each of these positions. Checking module 148 updates user account data in first storage area 142a associated with the user station 16 (or the user that has identified her- or himself), dependent on the result of the comparison, dependent on whether the position indicated by the user is sufficiently close to any one of the positions. Thus, repeated use of the same segments can be handled. Similarly, if a multiple choice question is used, multiple answers can be handled as correct answers.

Although an embodiment has been described wherein the video data of the selected video segment is stored in storage system 142 and supplied from communication interface 140, it should be appreciated that instead the segment may be supplied by video delivery system 12 from video storage system 10. In this case, communication interface 140 may be coupled to video delivery system 12 to send a command to stream the video segment to user station 16 and to user station 16 to cause position selection input 30 to be displayed. This has the advantage that no storage space for separate storage of video data is needed for the questions. On the other hand separate storage has the advantage that the questions can be posed separately from video delivery system 12.

Although an embodiment has been described wherein images from the selected video segment are displayed and audio is played, in alternative embodiments only video or only audio may be played. In an embodiment only a spatial window in the images in the segment may be displayed, optionally in combination with rendering of sound from the segment. In another embodiment only subtitle text from the video items is displayed. These may be extracted for the selected segment from a sub-stream of the video items and stored in storage system 142 for use in the questions. Playing only audio or subtitles or only a window has the advantage that less storage space and bandwidth is needed for storing and transmitting the questions. Also, it may make the questions more challenging.

As noted, questions are generated by selecting a segment of a video item. In one embodiment the segment may be selected by randomly selecting a starting position and using a segment of predetermined duration from that starting position. Alternatively, a mark up version of the video item may be used, wherein scene cuts are indicated. Video scene cuts may be detected automatically from image changes in ways that are known per se. When the positions of scene cuts are available, the selection of starting positions may be limited to a selection from the positions of scene cuts. Similarly, the ends of the segments may be selected from the positions just before scene cuts, for example the first such scene cut after a time interval of predetermined duration from the selected start of the segment. In other embodiments selections from other predetermined sets of starting points may be made.

Although embodiments have been described for video items, it should be appreciated that more generally, any kind of media item may be used. As used herein, a media item means data representing an image, a stream of video images, and/or a stream of audio signal samples, or more generally any data representing a human perceivable signal with signal values that depend on temporal and/or spatial position, or a stream of data representing text. A video item is a media item that represents at least a temporal series of images.

Although an embodiment has been described wherein questions are generated by selection of temporal segments, it should be appreciated that questions may also be generated by selecting spatial segments in an image from the video stream. In this case the user may be asked to indicate the 2D position of a segment in an image. This may be used instead of temporal segments, or in combination with them. As used herein position refers to a temporal position in a temporal stream of video images and/or spatial position in an image, or more generally any temporal or spatial position in a signal with signal values that depend on temporal and/or spatial position.

Although an embodiment has been described wherein questions about video items such as movies are generated, it should be appreciated that similar questions may be generated about an audio item such as a recording of a concert, using selected temporal segments from the audio item. Similar questions may be generated about a single image, using selected spatial segments from the image.

Although an embodiment has been described wherein one network is used to couple user stations 16 to video delivery system 12 and video delivery control system 14, it should be appreciated that different networks may be used. Similarly, video delivery control system 14 may be coupled to video delivery system 12 via a network, such as communication network 18.

Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor or other unit may fulfill the functions of several items recited in the claims. The mere fact that certain measures are recited in mutually different dependent claims does not indicate that a combination of these measured cannot be used to advantage. A computer program may be stored/distributed on a suitable medium, such as an optical storage medium or a solid-state medium supplied together with or as part of other hardware, but may also be distributed in other forms, such as via the Internet or other wired or wireless telecommunication systems. Any reference signs in the claims should not be construed as limiting the scope.

1. A method of providing automatic generation of questions to users about a media item and evaluation of user answers to the generated questions, the method comprising:
selecting a media segment of the media item, the selected segment having a first position within the media item;
rendering at least part of the media item within the selected media segment;
receiving an indication of a second position within the media item from a user;
evaluating a difference between the first and second position.

2. The method according to claim 1, comprising spatially displaying a selection range, inputting a user selection of a spatial position within the spatially displayed selection range, and deriving the second position from the inputted spatial position.

3. The method according to claim 1, the method further comprising:
selecting a plurality of mutually different positions in the media item, including said first position; and
rendering a representation of each of said plurality of positions;
the indication of a second position being received as a selection from the representations of the positions in said plurality of positions.

4. The method according to claim 1, comprising transmitting the media item or a further media item to the user upon receiving an electronic payment of a predetermined payment amount or deducting the payment amount from a user account, the payment amount being determined dependent on a difference between the first and second position.

5. The method according to claim 1, further comprising:
controlling said selecting of the media segment dependent on a list of previously selected media segments of the media item, to disable a selection wherein the first position is within a predetermined distance from a position of any of the segments in said list;
adding the selected segment to the list; and
repeating selecting, rendering, receiving, evaluating and adding for said media item to generate different questions about the media item.

6. The method according to claim 1, wherein the segment is selected by randomly selecting the first position within a range of signal positions in the media item.

7. The method according to claim 1, wherein the first position is a temporal position in a stream of signal samples defined by the media item.

8. The method according to claim 1, comprising directly or indirectly comparing at least part of a content of the media item in the selected segment with content of the media item outside the segment and adapting the question or the evaluation of the indicated second position dependent on a result of the comparison.

9. The method according to claim 1, wherein the media item represents a video stream.

10. The method according to claim 9, wherein said rendering comprises rendering only an audio component of the video stream in said media segment or a subtitle text, without displaying more than one image from the video stream.

11. The method according to claim 9, wherein said rendering comprises rendering only an audio component of the video stream in said media segment or a subtitle text, without displaying any image from the video stream.

12. A computer program product comprising a program of instructions for a programmable computer, the program, when executed by the computer, causing the computer to perform the method of claim 1.

13. A system comprising a user quizzing component for automatically generating questions about a media item and evaluating user answers to the generated questions, comprising:
a selector that is configured to select a media segment of the media item, the selected segment having a first position within the media item;
a renderer that is configured to cause at least part of the media item within the selected segment to be rendered;
an input for receiving an indication of a second position within the media item from a user; and
a comparator configured to evaluate a difference between the first and second position.

14. The system according to claim 13, wherein said selector is configured to control said selecting of the media segment dependent on a list of previously selected media segments of the media item, to disable a selection wherein the first position is within a predetermined distance from a position of any of the segments in said list, to add the selected segment to the list, and to repeat selecting, rendering, receiving, evaluating and adding for said media item to generate different questions about the media item.

15. The system according to claim 13, wherein said selector is configured to select the segment by randomly selecting the first position within a range of signal positions in the media item.
